(19) United States
(12) Patent Application Publication
(10) Pub. No.: US 2013/0222149 A1
(43) Pub. Date: Aug. 29, 2013

(54) Mud Pulse Telemetry Mechanism Using Power Generation Turbines

(71) Applicant: Schlumberger Technology Corporation, (US)

(72) Inventors: Fei Li, Gloucestershire (GB); Tamir El-Halawani, Gloucestershire (GB)

(73) Assignee: Schlumberger Technology Corporation, Sugar Land, TX (US)

(21) Appl. No.: 13/773,665

(22) Filed: Feb. 22, 2013

Related U.S. Application Data
(60) Provisional application No. 61/602,731, filed on Feb. 24, 2012.

(51) Int. Cl. G01V 3/18

(52) U.S. Cl. CPC G01V 3/18
USPC 340/854.3

(57) ABSTRACT

A method and apparatus of creating a mud pulse for a drilling system, comprising creating a mud flow through the drilling system and creating at least one pressure pulse in the mud flow with a power generation mechanism.

### FIELD OF THE INVENTION

Aspects relate to mud pulse telemetry systems. More specifically, aspects relate a mud pulse telemetry mechanism that utilizes power generation turbines.

### BACKGROUND

Conventional mud pulse telemetry systems generate pressure pulses in mud traveling through a downhole drilling system through a specially designed mud pulse arrangement that is placed within a mud flow in a downhole environment. These conventional mud pulse telemetry systems use a specially designed rotor that permits and then restricts mud flow. The pressure pulses by these specially designed rotors may encode information that may be received, for example, at an uphole location and demodulated. This demodulated data may contain information related to downhole formation parameters and drilling progress.

Other systems may be used to provide communication from a downhole environment to an uphole environment. Such systems may include electromagnetic systems, sonic systems or wired systems. Each one of these conventional systems has inherent difficulties. These inherent difficulties include high cost, decreased reliability and complex downhole string arrangements to accomplish the necessary functions.

### SUMMARY

Power generation turbines have been widely used to generate power for electronic systems in downhole tools by using hydraulic power of mud flows. It is proposed to use the existing power generation turbines as a telemetry transmitter whilst power generation. The information can be demodulated by a pressure sensor on another tool or tools within a BHA. The amplitude of the rotor rotation speed variation can be optimized to a relatively low level so as to not affect proper power delivery to tools. Additionally, the frequency spectrum of the modulation can be in different frequency spectrums from downlinks and MWD mud pulses sending to surface.

Further, a method of creating a mud pulse for a drilling system includes creating a mud flow through the drilling system and creating at least one pressure pulse in the mud flow with a power generation mechanism. Aspects described herein are not limited to this particular embodiment, as other alternative embodiments are applicable.

### BRIEF DESCRIPTION OF DRAWINGS

FIG. 1 is a system block diagram of mud pulse telemetry mechanism using a power generation module with electric loads;

FIG. 2 is a system block diagram of mud pulse telemetry mechanism using a power generation module with two stator windings;

FIG. 3 is a method for producing, transmitting and receiving mud pulse telemetry signals according to an aspect described; and

FIG. 4 is an arrangement for downhole drilling.

### DETAILED DESCRIPTION

It will be understood that the following disclosure provides many different embodiments, or examples, for implementing different features of various embodiments. Specific examples of components and arrangements are described below to simplify the present disclosure. These are, of course, merely examples and are not intended to be limiting. In addition, this disclosure may repeat reference numerals and/or letters in the various examples. This repetition is for the purpose of simplicity and clarity and does not itself dictate a relationship between the various embodiments and/or configurations discussed. Moreover, the subterranean formation of a first feature over or on a second feature in the description may include embodiments in which the first and second features are formed in direct contact, and may also include embodiments in which additional features may be formed interposing the first and second features, such that the first and second features may not be in direct contact.

In accordance with the present disclosure, a wellsite with associated wellbore and apparatus is described in order to describe one, but not limiting, embodiment of the application. To that end, apparatus at the wellsite may be altered due to field considerations encountered.

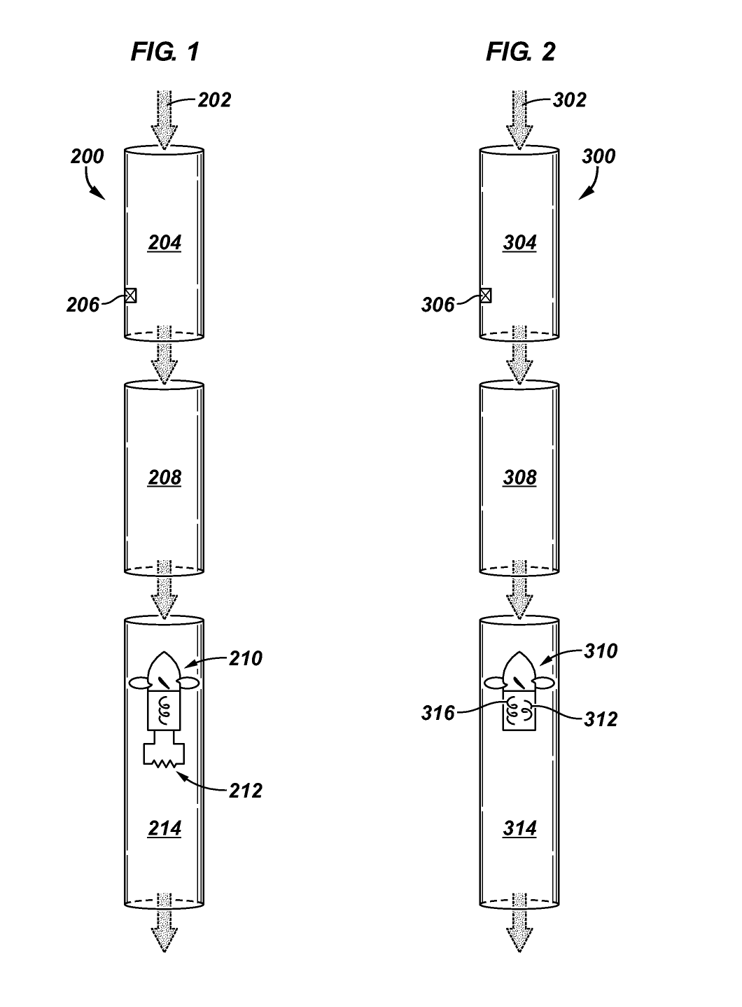

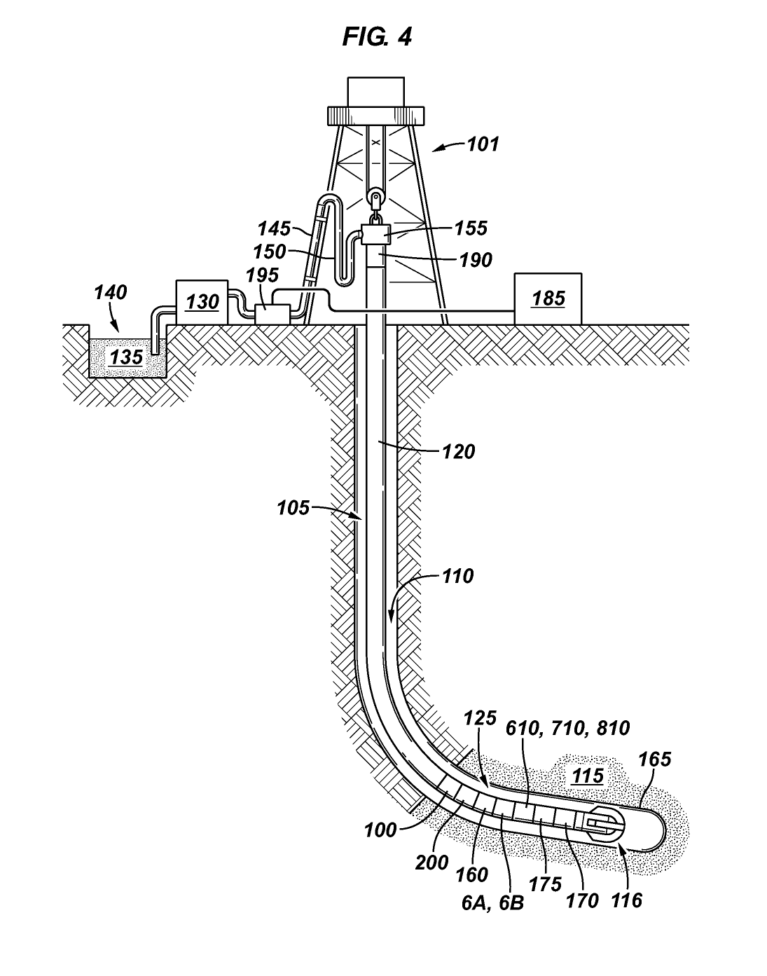

An example well site system is schematically depicted in FIG. 4 wherein components described above are incorporated in the larger systems described therein. The well site comprises a well 110. A drill string 105 may extend from a drill rig 101 into a zone of the formation of reservoir 115. The drill string 105 uses a telemetry system 100 for transmitting data from downhole to the surface. In the illustrated embodiment, the telemetry system 100 is a mud pulse telemetry system. The specifics of the mud pulse telemetry system are described in relation to FIGS. 1 and 2.

Although illustrated with a mud pulse telemetry, the drill string 105 may additionally use any type of telemetry system or any combination of telemetry systems, such as electromagnetic, acoustic and\or wired drill pipe, however in the embodiment disclosed, a the mud pulse telemetry system is used. A bottom hole assembly (“BHA”) is suspended at the end of the drill string 105. In an embodiment, the bottom hole assembly comprises a plurality of measurement while drilling or logging while drilling downhole tools 125, such as shown by numerals 6a and 6b. For example, one or more of the downhole tools 6a and 6b may be a formation pressure while drilling tool.

Logging while drilling (“LWD”) tools used at the downhole end of the drill string 105 may include a thick walled housing, commonly referred to as a drill collar, and may include one or more of a number of logging devices. The logging while drilling tool may be capable of measuring, processing, and/or storing information therein, as well as communicating with equipment disposed at the surface of the well site.

Measurement while drilling (“MWD”) tools used along with the drill string may include one or more of the following measuring tools: a modulator, a weight on bit measuring device, a torque measuring device, a vibration measuring device, a shock measuring device, a stick-slip measuring device, a direction measuring device, and inclination measuring device, and\or any other device.

Measuring made by the bottom hole assembly or other tools and sensors with the drill string 105 may be transmitted to a computing system 185 for analysis. For example, mud pulses may be used to broadcast formation measurements performed by one or more of the downhole tools 6a and 6b to the computing system 185.

The computing system 185 may be configured to host a plurality of models, such as a reservoir model, and to acquire and process data from downhole components, as well as determine the bottom hole location in the reservoir 115 from measurement while drilling data. Examples of reservoir models and cross well interference testing may be found in the following references: “Interpreting an RFT-Measured Pulse Test with a Three-Dimensional Simulator” by Lasseter, T., Karakas, M., and Schweitzer, J., SPE 14878, March 1988. “Design, Implementation, and Interpretation of a Three-Dimensional Well Test in the Cormorant Field, North Sea” by Bunn, G. F., and Yaxley, L. M., SPE 15858, October 1986. “Layer Pulse Testing Using a Wireline Formation Tester” by Saeedi, J., and Standen, E., SPE 16803, September 1987. “Distributed Pressure Measurements Allow Early Quantification of Reservoir Dynamics in the Jene Field” by Bunn, G. F., Wittman, M. J., Morgan, W. D., and Curnutt, R. C., SPE 17682, March 1991. “A Field Example of Interference Testing Across a Partially Communicating Fault” by Yaxley, L. M., and Blaymires, J. M., SPE 19306, 1989. “Interpretation of a Pulse Test in a Layered Reservoir” by Kaneda, R., Saeedi, J., and Ayestaran, L. C., SPE 19306, December 1991.

The drill rig 101 or similar looking/functioning device may be used to move the drill string 105 within the well that is being drilled through subterranean formations of the reservoir, generally at 115. The drill string 105 may be extended into the subterranean formations with a number of coupled drill pipes (one of which is designated 120) of the drill string 105. The drill pipe comprising the drill string 105 may be structurally similar to ordinary drill pipes, as illustrated for example and U.S. Pat. No. 6,174,001, issued to Enderle, entitled “Two-Step, a Low Torque, Wedge Thread for Tubular Connector,” issued Aug. 7, 2001, which is incorporated herein by reference in its entirety, and may include a cable associated with each drill pipe 120 that serves as a communication channel.

The bottom hole assembly at the lower end of the drill string 105 may include one, an assembly, or a string of downhole tools. In the illustrated example, the downhole tool string 105 may include well logging tools 125 coupled to a lower end thereof. As used in the present description, the term well logging tool or a string of such tools, may include at least one or more logging while drilling tools (“LWD”), formation evaluation tools, formation sampling tools and other tools capable of measuring a characteristic of the subterranean formations of the reservoir 115 and\or of the well.

Several of the components disposed proximate to the drill rig 101 may be used to operate components of the overall system. These components will be explained with respect to their uses in drilling the well 110 for a better understanding thereof. The drill string 105 may be used to turn and urge a drill bit 116 into the bottom the well 110 to increase its length (depth). During drilling of the well 110, a pump 130 lifts drilling fluid (mud) 135 from a tank 140 or pits and discharges the mud 135 under pressure through a standpipe 145 and flexible conduit 150 or hose, through a top drive 155 and into an interior passage inside the drill pipe 105. The mud 135 which can be water or oil-based, exits the drill pipe 105 through courses or nozzles (not shown separately) in the drill bit 116, wherein it cools and lubricates the drill bit 116 and lifts drill cuttings generated by the drill bit 116 to the surface of the earth through an annular arrangement.

When the well 110 has been drilled to a selected depth, the well logging tools 125 may be positioned at the lower end of the pipe 105 if not previously installed. The well logging tools 125 may be positioned by pumping the well logging downhole tools 125 down the pipe 105 or otherwise moving the well logging downhole tools 125 down the pipe 105 while the pipe 105 is within the well 110. The well logging tools 125 may then be coupled to an adapter sub 160 at the end of the drill string 105 and may be moved through, for example in the illustrated embodiment, a highly inclined portion 165 of the well 110, which would be inaccessible using armored electrical cable to move the well logging downhole tools 125.

During well logging operations, the pump 130 may be operated to provide fluid flow to operate one or more turbines in the well logging downhole tools 125 to provide power to operate certain devices in the well logging tools 125. When tripping in or out of the well 110, (turning on and off the mud pumps 130) it may be infeasible to provide fluid flow. As a result, power may be provided to the well logging tools 125 in other ways. For example, batteries may be used to provide power to the well logging downhole tools 125. In one embodiment, the batteries may be rechargeable batteries and may be recharged by turbines during fluid flow. The batteries may be positioned within the housing of one or more of the well logging tools 125. Other configurations and methods of powering the well logging tools 125 may be used including, but not limited to, one-time power use batteries.

As the well logging tools 125 are moved along the well 110 by moving the drill pipe 105, signals may be detected by various devices, of which non-limiting examples may include a resistivity measurement device, a bulk density measurement device, a porosity measurement device, a formation capture cross-section measurement device 170, a gamma ray measurement device 175 and a formation fluid sampling tool 610, 710, 810 which may include a formation pressure measurement device 6a and/or 6b. The signals may be transmitted toward the surface of the earth along the drill string 105.

An apparatus and system for communicating from the drill pipe 105 to the surface computer 185 or other component configured to receive, analyze, and/or transmit data may include a second adapter sub 190 that may be coupled between an end of the drill string 105 and the top drive 155 that may be used to provide a communication channel with a receiving unit 195 for signals received from the well logging downhole tools 125. The receiving unit 195 may be coupled to the surface computer 185 to provide a data path therebetween that may be a bidirectional data path.

Though not shown, the drill string 105 may also be connected to a rotary table, via a Kelly, and may suspend from a traveling block or hook, and additionally a rotary swivel. The rotary swivel may be suspended from the drilling rig 101 through the hook, and the Kelly may be connected to the rotary swivel such that the Kelly may rotate with respect to the rotary swivel. The Kelly may be any configuration has a set of polygonal connections or splines on the outer surface type that mate to a Kelly bushing such that actuation of the rotary table may rotate the Kelly.

An upper end of the drill string 105 may be connected to the Kelly, such as by threadingly reconnecting the drill string 105 to the Kelly, and the rotary table may rotate the Kelly, thereby rotating the drill string 105 connected thereto.

Although not shown, the drill string 105 may include one or more stabilizing collars. A stabilizing collar may be disposed within or connected to the drill string 105, in which the stabilizing collar may be used to engage and apply a force against the wall of the well 110. This may enable the stabilizing collar to prevent the drill pipe string 105 from deviating from the desired direction for the well 110. For example, during drilling, the drill string 105 may “wobble” within the well 110, thereby all owing the drill string 105 to deviate from the desired direction of the well 110. This wobble action may also be detrimental to the drill string 105, components disposed therein, and the drill bit 116 connected thereto. A stabilizing collar may be used to minimize, if not overcome altogether, the wobble action of the drill string 105, thereby possibly increasing the efficiency of the drilling performed at the well site and/or increasing the overall life of the components at the wellsite.

The system provided above may employ a rotary steerable system (“RSS”) or tool for directing the drilling system as the system progresses through the geological stratum. In another embodiment, the system may also provide other directional systems for drilling, as needed.

In the illustrated embodiment, some downhole tools are equipped with power generation modules which have fluid flow turbines to provide three-phase alternating current power to the tools. An electrical load connected to the power generation turbines can affect the rotation speeds of turbines. The changes in the rotation speed of the turbine will cause mud pressure variation in the drilling string. By controlling the mud pressure variation, the illustrated embodiments communication link is established from a downhole tool equipped with a turbine to either other downhole tool/tools equipped with a pressure sensor or uphole apparatus. Thus, the configurations provided allow for a communication link from one place to another within a bottom hole assembly in the borehole. Additionally, the systems described may be used for communication between a rotary steerable drilling tool and a MWD tool when they are separated by a mud motor as conventionally called vortex drilling configurations. This methodology may be deployed as a while—drilling communication link. As examples, FIGS. 1 and 2 illustrate, examples of the system diagram of a mud pressure telemetry mechanism wherein one system uses electrical load control the pressure modulation while the other system uses a control coil

In some applications, downhole tools use wired communication pathways between downhole tools or between the downhole environment and the uphole environment. In some cases, however, wired communication is impossible, and a wireless communication between tools or between the downhole environment and the uphole environment is utilized. There are several commercial communication systems, conventionally called short hops, in the oil and gas industry. Current commercial short hop systems use an electrical induction method or acoustic sounds. Normally, two short hop modules are utilized, one below and one above a separation module, to provide communication links over desired spans.

Power generation turbines have been widely used to generate power for electronic systems in downhole tools by using hydraulic power of mud flows. In such cases, turbine speed may be proportional to mud flow speed; however, the turbine rotation speed can be affected by the electrical load connected to turbines. With a constant mud flow, a variation of turbine rotation speed results in pressure variations. If a tool modulates message information onto the fluid flow by using a turbine, the message information can be demodulated by a pressure sensor on another tool or at an uphole environment.

Referring to FIG. 1 an example mud pulse telemetry mechanism is illustrated. In FIG. 1, the system uses an electrical load to control a pressure modulation thereby acting on the mud flow. In FIG. 2, the system illustrated uses a controlled coil to control pressure modulation acting on the mud flow.

Referring to FIG. 1, a mud pulse telemetry mechanism 200 that utilizes power generation turbines is illustrated. As illustrated, mud flow 202 is conducted through, for example, a measure while drilling (“MWD”) tool 204. In the illustrated embodiment, a pressure sensor 206 is used to determine the pressure of the mud flow 202 through the MWD tool 204. The pressure sensor 206 can be mounted inside or outside of the collar.

The mud flow 202 continues through the MWD tool 204 to the mud motor 208 located downhole. The mud flow 202 continues through to the power generation module (“PGM”) 210. The power generation module 210 is a unit that uses the mud flow 202 to provide electrical energy to connected components. As illustrated, the PGM 210 may be part of a rotary steerable system (“RSS”) tool 214. In an alternative configuration, the PGM 210 may be a stand-alone device and not incorporated in an RSS tool 214. In the illustrated embodiment, the turbine for the power generation module 210 is controlled such that the spinning of the turbine causes pressure fluctuations in the mud flow. In FIG. 1, the turbine speed is controlled through a connected electrical arrangement 212. In this specific embodiment, the turbine is controlled by connecting and disconnecting to an electrical load. The electrical load can be any type of variable load arrangements and the connecting and disconnecting scheme is not limited to switches and can be other types of power electronic control strategy. Due to the load changes, turbine rotor rotation speeds varies accordingly to generate pressure variation. Switching on and off one electrical load is able to generate high and low pressure values representing binary digits.

Referring to FIG. 2, a second example embodiment is provided. In this second example embodiment, a mud pulse telemetry mechanism 300 that utilizes power generation turbines is illustrated. As illustrated, mud flow 302 is conducted through, for example, a measure while drilling (“MWD”) tool 304. In the illustrated embodiment, a pressure sensor 306 is used to determine the pressure of the mud flow 302 through the MWD tool 304.

The mud flow 302 continues through the MWD tool 304 to the mud motor 308 located downhole. The mud flow 302 continues through to the power generation module (“PGM”) 310. The power generation module 310 is a unit that uses the mud flow 302 to provide electrical energy to connected components. As illustrated, the PGM 310 may be part of a rotary steerable system (“RSS”) tool 314. In an alternative configuration, the PGM 310 may be a stand-alone device and not incorporated in an RSS tool 314. In the illustrated embodiment, the turbine is built with two stator windings 312 and 316, for example, a winding with three-phase power generation and a control winding for rotor speed control. In this example embodiment, the pressure variation exerted on to the fluid can be generated by applying varying current through the control stator windings. The differences in the current will cause the turbine to actuate at different rates, consequently allowing for pulses to be generated in the mud flow.

The pressure variations may be used to modulate useful information that is sent from a tool to another tool or tools within a bottom hole assembly (“BHA”) as well as from a downhole environment to an uphole environment. The amplitude of the rotor rotation speed variation may be optimized to a relatively low level, which does not affect proper power delivery to tools; furthermore, the frequency spectrum of the modulation could be designed to be in different frequency spectrums from downhole measure while the drilling mud pulse system is sending information to the surface.

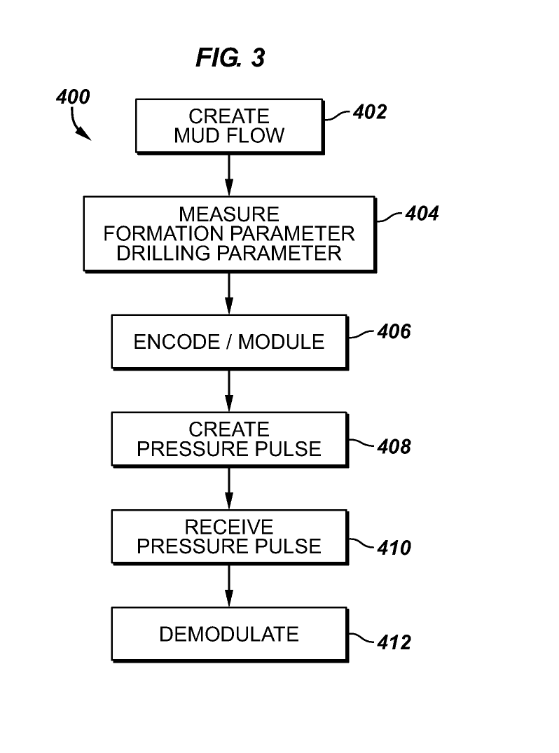

Referring to FIG. 3, a method 400 for creating a pressure pulse with a mud pulse telemetry mechanism using a power generation turbine is illustrated. In 402 a mud flow is established throughout the system. The mud flow will be the medium by which the pressure pulses will be transported from a first point to a second point or multiple points. Transportation may be from a first tool to a second tool for from a downhole environment to a point removed from the downhole environment, wherein the point removed may be increased in depth, decreased in depth or equal in depth to the original. In 404 a drilling parameter or a measured formation parameter is determined to be transported from a first position to a second position. The data may also be other communications that are desired and not directly related to a drilling parameter or a measured formation parameter; therefore the description should not be considered limiting. The data may enter an arrangement and be encoded in 406 such that the parameter is digitized for transmission. In 408, pressure pulses are created, for example, according to the desired encoding in 406, wherein the power generation turbine exerts force on the mud flow established throughout the system 302. In 410, the pressure pulse is received at the second point. In 412 the data received may be demodulated.

In one example embodiment, a method of creating a mud pulse for a drilling system is disclosed comprising creating a mud flow through the drilling system; and creating at least one pressure pulse in the mud flow with a power generation mechanism.

In another example embodiment, the method may be accomplished wherein the receiving the at least one pressure pulse at a receiving arrangement.

In another example embodiment, the method may be accomplished wherein measuring at least one of a drilling parameter and a formation parameter prior to creating the at least one pressure pulse and modulating data from the measured at least one of a drilling parameter and a formation parameter such that the at least one pressure pulse corresponds to at least a portion of the modulated data.

In another example embodiment, the method may be accomplished wherein the creating the at least one pressure pulse in the mud flow is through a power generation mechanism that has at least one control winding and at least one power winding.

In another example embodiment, the method may be accomplished wherein the power generation mechanism is incorporated in a rotary steerable downhole tool.

In another example embodiment, the method may be accomplished wherein a speed of the power generation mechanism is proportional to a speed of the mud flow.

In another example embodiment an arrangement is disclosed comprising a power generation mechanism configured to actuate a drilling mud to create a pressure pulse in a drilling mud flow.

In another example embodiment, the arrangement is provided wherein the power generation mechanism has at least two windings.

In another example embodiment, the arrangement is provided wherein at least one of the windings is a power winding and a second of the at least two windings is a control winding.

In a further example embodiment, the arrangement wherein the power generation mechanism is configured as part of a rotary steerable system tool.

In another example embodiment the arrangement is accomplished wherein the power generation mechanism is at least one power generation turbine.

In another example embodiment, the arrangement has at least two windings that are three-phase power generation windings.

While aspects have been disclosed with respect to a limited number of embodiments, those skills in the art, having the benefit of this disclosure, will appreciate numerous modifications and variations therefrom. It is intended that the appended claims cover such modifications and variations as within the true spirit and scope of the invention.

What is claimed is:

1. A method of creating a mud pulse for a drilling system, comprising:
creating a mud flow through the drilling system; and
creating at least one pressure pulse in the mud flow with a power generation mechanism.

2. The method according to claim 1, further comprising:
receiving the at least one pressure pulse by a receiving including a device configured to measure a pressure change.

3. The method according to claim 1, further comprising:
measuring at least one data value for a drilling parameter, a diagnostic information and a formation parameter prior to creating the at least one pressure pulse; and
modulating the at least one data value such that the at least one pressure pulse corresponds to at least a portion of the modulated data value.

4. The method according to claim 1, wherein creating the at least one pressure pulse in the mud flow includes flowing mud through a power generation mechanism including at least one control winding and at least one power winding.

5. The method according to claim 1, wherein creating the at least one pressure pulse in the mud flow includes flowing mud through a power generation mechanism having controlled variable electrical load.

6. The method according to claim 3, further comprising:
receiving the modulated data value at a location remote the point of creation of the at least one pressure pulse.

7. The method according to claim 1, wherein a speed of the power generation mechanism is proportional to a speed of the mud flow.

8. An arrangement, comprising:
a power generation mechanism configured to actuate a drilling mud to create a pressure pulse in a drilling mud flow.

9. The arrangement according to claim 8, wherein the power generation mechanism includes at least two windings.

10. The arrangement according to claim 8, wherein at least one of the windings is a power winding and at least one of the windings is a control winding.

11. The arrangement according to claim 8, wherein the power generation mechanism is configured as part of a rotary steerable system, LWD or MWD tool.

12. The arrangement according to claim 8, wherein the power generation mechanism includes at least one power generation turbine.

13. The arrangement according to claim 9, wherein the at least two windings are three-phase power generation windings.

14. The arrangement according to claim 8, wherein the power generation mechanism has controlled variable electrical load.

15. The arrangement according to claim 8, wherein the controlled electrical load can be any type of variable electrical load with a control strategy to increase and decrease the load values.
